(19) United States
(12) Patent Application Publication
(10) Pub. No.: US 2008/0002545 A1
(43) Pub. Date: Jan. 3, 2008

(54) Optical disc apparatus and optical disc determining method

(76) Inventor: Yoshinori Tazaki, Yokohama-Shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/824,315

(22) Filed: Jun. 29, 2007

(30) Foreign Application Priority Data
Jun. 30, 2006 (JP) 2006-181618

(51) Int. Cl. G11B 7/00

(52) U.S. Cl. 369/53.2

(57) ABSTRACT

An optical disc apparatus includes a pickup unit, a pickup control unit, a data reading circuit, a PLL control circuit, a CPU, a RAM, a ROM, an LED drive circuit, an LED display unit, and an interface circuit. The CPU functions as at least a CD/DVD determining unit, a type-of-disc determining unit, a thread motor drive unit, a focusing servo executing unit, an obtaining unit, a threshold calculating unit, a number-of-peaks calculating unit, and a checking unit.

### CROSS-REFERENCE TO RELATED APPLICATIONS

This application claims the benefit of priority of Japanese Patent Application No. 2006-181618, filed Jun. 30, 2006, the entire contents of which are incorporated herein by reference.

### BACKGROUND

1. Field

The present invention relates to an optical disc apparatus and an optical disc determining method using a CD, a DVD, or an HD DVD.

2. Description of the Related Art

A known example of determining the type of the optical disc disclosed in Japanese Unexamined Patent Application Publication No. 2005-259252.

A disc drive apparatus disclosed in Japanese Unexamined Patent Application Publication No. 2005-259252 includes control unit that controls the strength and the focal point of laser beams emitted to an optical disc, and determines a CD-system disc or a DVD-system disc on the basis of a measurement result of a time interval between the timing for obtaining reflection of a surface of the optical disc and the timing for obtaining reflection of a recording layer of the optical disc. Further, laser beams having wavelengths corresponding to the CD system and DVD system are emitted on the basis of the determination result, thereby obtaining a focus error signal (hereinafter, referred to as an FE signal). Furthermore, the type of optical discs is specified in detail on the basis of a peak value of the FE signal.

The peak value of the FE signal is in proportion to the reflectance of the optical disc. The level of reflectance is varied depending on the type of optical discs. Therefore, the type of optical disc is specified in detail on the basis of the peak value of the FE signal.

However, the conventional technology for determining the optical disc mainly has the following two problems, in particular, in view of the determination of a DVD-RAM disc.

First, there is such a problem that the determination itself takes a long time. With the conventional technology, a DVD-RAM is first determined from DVD-system discs, laser beams compatible with the DVD system are then lit-on, and servo adjustment is variously performed, thereby obtaining the peak value of the FE signal. Low reflection to a single layer of the DVD (DVD-RAM or DVD±RW) is determined based on the peak value of the FE signal and this DVD-RAM is thereafter determined in a track-on state. Hence, the number of necessary routines is large and thus the determination takes a long time.

Secondly, there is a problem of noise. In general, it is considered that the determination in the track-off state is effective for reduction in determination time. However, in the track-off state, an RF signal and an LPP signal become noise and the noise causes the fail of determination.

Unlike other optical discs, the DVD-RAM uses a CAPA (Complimentary Allocated Pit Addressing) as an address signal (header) system. As compared with portions (data recording track, etc.) other than the CAPA (header), the CAPA has an extremely high reflectance. Further, CAPA is recorded every sector in the DVD-RAM. Therefore, a predetermined number of CAPAs regularly exist every circumference of the disc. For example, there are 17 CAPAs in Ver1 of DVD-RAM and 25 CAPAs in Ver2 thereof every circumference of the disc.

That is, when the reflectance of the DVD-RAM is measured in the circumferential direction of the disc, portions with a high reflectance regularly exist.

Therefore, in order to specify the optical disc having the portions with the high reflectance of DVD-RAM, which are regularly arranged in the circumferential direction, information on the strength of reflection light corresponding to one circumference of the optical disc may be used.

Further, at the portions with the high reflectance, light is reflected with a higher reflectance as compared with another portion. These portions with the high reflectance are not influenced from the noise.

### SUMMARY OF THE INVENTION

The present invention is devised in consideration of the above conditions and it is an object of the present invention to provide an optical disc apparatus and an optical disc determining method for easily specifying, for a short time, an optical disc having portions with a high reflectance, which are regularly arranged in the circumferential direction.

In order to solve the above problem, the optical disc apparatus according to one aspect of the present invention is an optical disc apparatus, includes: a storing unit configured to store certain information, such information including (i) a threshold calculation expression, (ii) the number of portions with high reflectance corresponding to one circumference of an optical disc, wherein the portions with high reflectance are regularly arranged in the circumferential direction of the optical disk, and (iii) the type of optical disc having the portions with high reflectance, wherein the type correlates to the number of portions with high reflectance; an obtaining unit configured to obtain an output of total addition signals, corresponding to one or more rotations of a loaded optical disc; a threshold calculating unit configured to calculate a maximum value and an average value of the output of the total addition signals, and further configured to calculate a threshold on the basis of the threshold calculation expression by using the calculated maximum value and the average value; a number-of-peaks calculating unit configured to calculate the number of peaks of the output of the total addition signals, each peak corresponding to one rotation of the loaded optical disc, above the threshold; a checking unit configured to compare the number of peaks with the number of portions with high reflectance; and a type-of-disc determining unit configured to determine, when the number of portions with high reflectance matching the number of peaks is stored in the storing unit or when the number of portions with high reflectance at which an absolute of difference from the number of peaks is not more than 5 is stored in the storing unit, that the type of loaded optical disc is the type of optical disc having the portions with high reflectance, wherein the type correlates to the number of portions with high reflectance.

Further, in order to solve the above problem, the optical disc determining method according to another aspect of the present invention is an optical disc determining method includes the steps of: obtaining an output of total addition signals corresponding to one rotation of a loaded optical disc; calculating a maximum value and an average value of the output of the total addition signals and further calculating a threshold by using the calculated maximum value and average value; calculating the number of peaks of the output of the total addition signals corresponding to one rotation of the loaded optical disc, over the threshold; checking the number of peaks with the number of portions with high reflectance corresponding to one rotation of an optical disc, wherein the portions with high reflectance are regularly arranged in the circumferential direction; and determining, when the number of peaks matches the number of portions with high reflectance or when an absolute of difference between the number of peaks and the number of portions with high reflectance is not more than 5, that the type of loaded optical disc is the type of optical disc having the portions with high reflectance, wherein the type correlates to the number of portions with high reflectance.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing the entire structure of an optical disc apparatus according to the first embodiment of the present invention;

FIG. 2 is a block diagram schematically showing an example of the structure of units of a CPU;

FIG. 3 is a flowchart showing one routine for specifying an optical disc having portions with a high reflectance, regularly-arranged in the circumferential direction of the optical disc on the basis of information on reflection of the optical disc with the optical disc apparatus shown in FIG. 1;

FIG. 4 is an explanatory diagram showing a relationship between total addition signals corresponding to one rotation of a DVD-RAM (Ver2) and a threshold T calculated on the basis of expression (2);

FIG. 5 is an explanatory diagram showing a relationship between total addition signals corresponding to one rotation of an optical disc other than the DVD-RAM and a threshold T calculated on the basis of expression (2);

FIG. 6 is a flowchart showing another routine for specifying an optical disc having portions with a high reflectance, regularly-arranged in the circumferential direction of the optical disc on the basis of information on reflection of the optical disc with the optical disc apparatus shown in FIG. 1;

FIG. 7 is an explanatory diagram showing a relationship between total addition signals corresponding to one rotation of a DVD-RAM (Ver2), a threshold T calculated on the basis of expression (2), and the threshold T±hysteresis voltage α; and

FIG. 8 is an explanatory diagram showing a relationship between total addition signals corresponding to one rotation of an optical disc other than the DVD-RAM, a threshold T calculated on the basis of expression (2), and a threshold T±hysteresis voltage α.

### DETAILED DESCRIPTION

Hereinbelow, a description will be given of an optical disc apparatus and an optical disc determining method according to embodiments of the present invention with reference to the drawings.

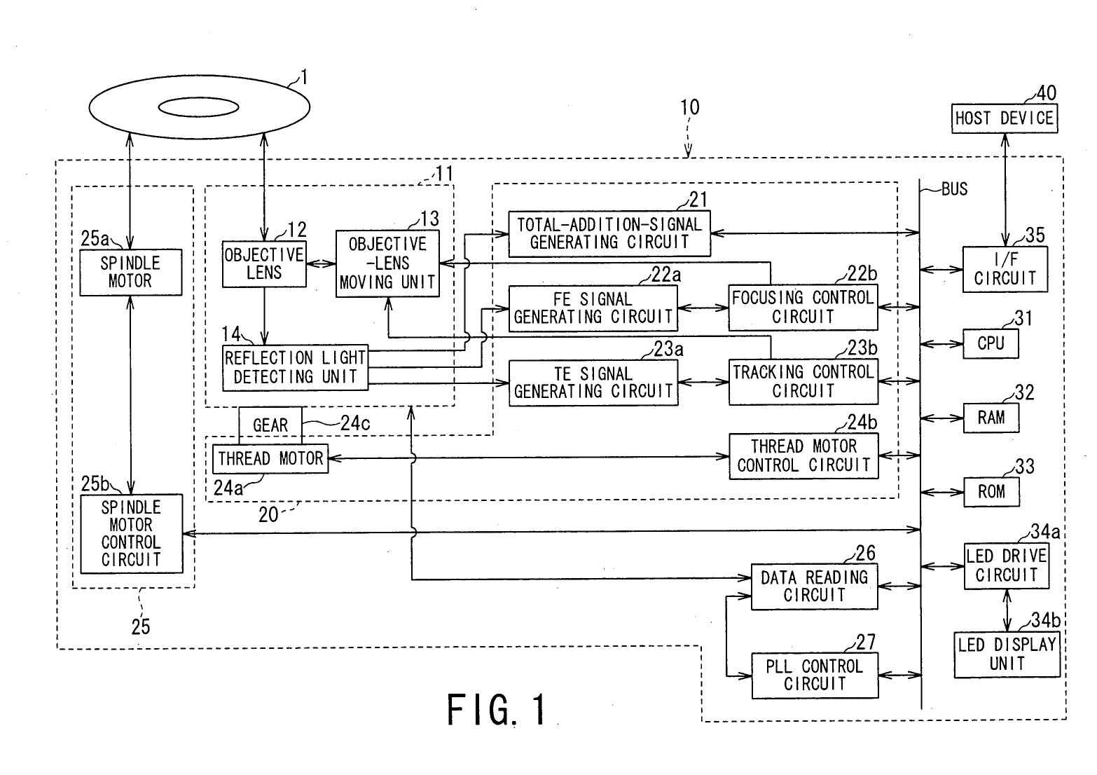

FIG. 1 is a diagram schematically showing the entire structure of an optical disc apparatus according to the first embodiment of the present invention.

An optical disc apparatus 10 includes a pickup unit 11, a pickup control unit 20, a spindle motor unit 25, a data reading circuit 26, a PLL control circuit 27, a CPU 31, a RAM 32, a ROM 33, an LED drive circuit 34a, an LED display unit 34b, and an interface circuit 35.

The pickup unit 11 includes at least an objective lens 12 that focuses laser beams to an optical disc 1, objective-lens moving unit 13 that moves the objective lens 12 in the vertical (thickness) direction (focusing direction) and horizontal (radius) direction (tracking direction) of a recording surface of the optical disc 1, and reflection light detecting unit 14 that detects reflection light of the optical disc 1 and outputs a signal corresponding to the reflection light.

The objective-lens moving unit 13 is controlled by a focusing control circuit 22b and a tracking control circuit 23b. The objective-lens moving unit 13 generally contains a coil and a magnet because magnetic force is used for movement of the objective lens 12.

The reflection light detecting unit 14 includes a plurality of light detecting cells (photodiodes, etc.) arranged on the single surface at positions for receiving the reflection light from the optical disc 1. The light detecting cells receive reflection beams of the laser beams from the recording surface of the optical disc 1 at the positions, and output data corresponding to the strength of the received light. The output from the reflection light detecting unit 14 corresponds to collection of the outputs from the plurality of light detecting cells.

The pickup control unit 20 includes a total-addition-signal generating circuit 21, a focusing error (FE) signal generating circuit 22a, the focusing control circuit 22b, a tracking error (TE) signal generating circuit 23a, the tracking control circuit 23b, a thread motor 24a, and a thread motor control circuit 24b.

The total-addition-signal creating circuit 21 receives information on the reflection light of the laser beams from the recording surface of the optical disc 1 from the reflection light detecting unit 14 and outputs signals (total addition signals) corresponding to the strength of the reflection light. The total addition signals become maximum in a state in which the laser beams are completely focused to the recording surface of the optical disc 1 (hereinafter, referred to as just-focusing).

The FE signal generating circuit 22a receives information on the reflection light of the laser beams from the recording surface of the optical disc 1 from the reflection light detecting unit 14, and outputs a signal (FE signal) corresponding to the deviation from the just-focusing state when the objective lens 12 is moved in the vertical direction of the recording surface of the optical disc 1.

The focusing control circuit 22b controls the objective-lens moving unit 13 on the basis of the FE signal received from the FE signal generating circuit 22a so as to move the objective lens 12 to the just-focusing position.

The TE signal generating circuit 23a receives information on the reflection light of the laser beams from the recording surface of the optical disc 1 from the reflection light detecting unit 14, and outputs a signal (TE signal) corresponding to the deviation from a just-focusing state, in which the objective lens 12 is moved to the center of track, when the objective lens 12 is moved in the radial direction of the optical disc 1.

The tracking control circuit 23b controls the objective-lens moving unit 13 on the basis of the TE signal received from the TE signal generating circuit 23a so as to move the objective lens 12 to the just-tracking position.

The thread motor 24a is connected, via a gear 24c, to the pickup unit 11 attached to a chassis (not shown) slidable in the radial direction of the optical disc 1. The thread motor 24a moves the pickup unit 11 in the radial direction of the optical disc 1, and the width of this movement is larger than the width of the movement of the objective-lens moving unit 13. The thread motor control circuit 24b controls the operation of the thread motor 24a.

Even in a state in which the tracking control circuit 23b does not control the objective-lens moving unit 13 (hereinlater, referred to as a track-off state), the thread motor 24a can move the pickup unit 11 in the radial direction of the optical disc 1.

The spindle motor unit 25 includes a spindle motor 25a and a spindle motor control circuit 25b. The spindle motor 25a rotates the optical disc 1. The spindle motor control circuit 25b controls the operation of the spindle motor 25a.

The data reading circuit 26 reads recording data of the optical disc 1 on the basis of a reading clock signal received from the PLL control circuit 27.

The CPU 31 controls the processing operation of the optical disc apparatus 10 under a program stored in the ROM 33. The CPU 31 loads, to the RAM 32, an optical-disc determining program and data necessary for executing the program stored in the ROM 33, and executes processing for determining the type of the optical disc 1 under the optical-disc determining program.

The RAM 32 provides a work area for temporarily storing data and the program executed by the CPU 31.

The ROM 33 stores a start program of the optical disc apparatus 10, the optical-disc determining program, and various data necessary for executing the programs. The ROM 33 stores in advance, various data having at least data on the distance from the surface of the CD system or DVD system to the recording layer, a threshold calculation expression, the number of portions with a higher reflectance corresponding to one circumference of the optical disc, and the type of disc correlated with the number of portions with the high reflectance.

Incidentally, the ROM 33 may include a storage medium readable by the CPU 31, such as a magnetic or optical storage medium or a semiconductor memory, and may download a part or all of the program and data in the ROM 33 via an electronic network.

The LED display unit 34b is controlled by the LED drive circuit 34a, and displays the operation state of the optical disc apparatus 10.

The interface circuit 35 is connected to a host device 40 serving as an external computer. Via the interface circuit 35, the host device 40 and the optical disc apparatus 10 communicate data with each other.

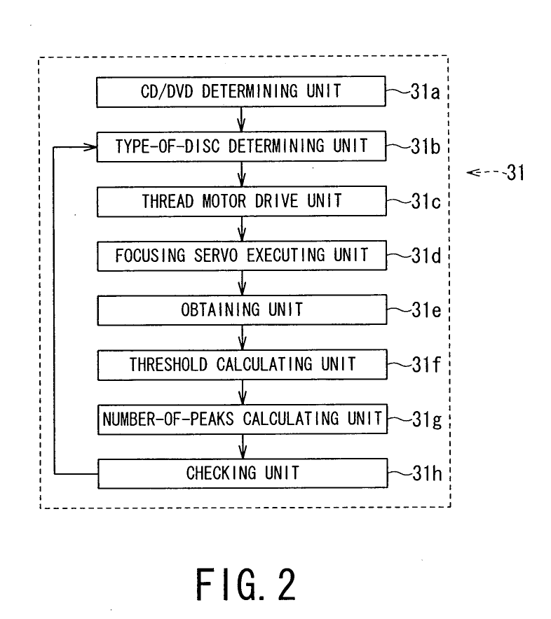

FIG. 2 is a block diagram schematically showing a structure example of units of the CPU 31.

The CPU 31 functions as at least CD/DVD determining unit 31a, type-of-disc determining unit 31b, thread motor drive unit 31c, focusing servo executing unit 31d, obtaining unit 31e, threshold calculating unit 31f, number-of-peaks calculating unit 31g, and checking unit 31h of the number of portions with a high reflectance, under the optical-disc determining program stored in the ROM 33. These units use a predetermined work area of the RAM 32 as a portion for temporarily storing the data. Incidentally, these units may provided by hardware logic, without using the CPU.

The CD/DVD determining unit 31a has a function for determining, with a general method, whether the optical disc 1 is a CD system or a DVD system, and sending the determination result to the type-of-disc determining unit 31b. The general method includes a method for using the difference in thickness between the CD system and the DVD system (˜1.2 mm in the case of the CD system and ˜0.6 mm in the case of the DVD system) or a method for using the difference in reflectance (that of the DVD system is approximately ½ of that of the CD system).

The type-of-disc determining unit 31b has a function for determining the type of the optical disc 1 and outputting information on the determination result to the host device 40 via the interface circuit 35. Further, when the number of portions with the high reflectance (hereinafter, referred to as the number of stored CAPAs) stored in advance in the ROM 33 is received from the checking unit 31h, the type-of-disc determining unit 31b has a function for reading the type of the optical discs correlated with the number of stored CAPAs and outputting the type of optical disc to the host device 40 via the interface circuit 35.

The thread motor drive unit 31c has a function for moving the pickup unit 11 to the positions of laser beams with a high reflectance on the optical disc 1 by driving the thread motor 24a via the thread motor control circuit 24b.

The focusing servo executing unit 31d has a function for controlling the laser beams to be in the just-focusing state by driving the objective-lens moving unit 13 via the focusing control circuit 22b and further has a function of the focusing operation.

The obtaining unit 31e has a function for rotating the optical disc 1 by driving the spindle motor 25a via the spindle motor control circuit 25b. Further, the obtaining unit 31e has a function for obtaining at least the output of the total addition signals corresponding to one rotation from the total-addition-signal generating circuit 21 and storing the obtained data to a predetermined area of the RAM 32.

The threshold calculating unit 31f has a function for calculating a maximum value P and an average value Ave on the basis of the data on the output of the total addition signals from the total-addition-signal generating circuit 21. Further, the threshold calculating unit 31f has a function for calculating a threshold T on the basis of the calculated maximum value P and average value Ave by using the threshold calculation expression stored in advance in the ROM 33.

The number-of-peaks calculating unit 31g has a function for comparing the data on the output of the total addition signal from the total-addition-signal generating circuit 21 with the threshold T calculated by the threshold calculating unit 31f, and calculating a number n of pulses (peaks) over the threshold T.

The checking unit 31h has a function for comparing the number of portions with the high reflectance stored in advance in the ROM 33 with the number n of peaks calculated by the number-of-peaks calculating unit 31g and sending the comparison result to the type-of-disc determining unit 31b.

Next, a description will be given of the operation of the optical disc apparatus 10.

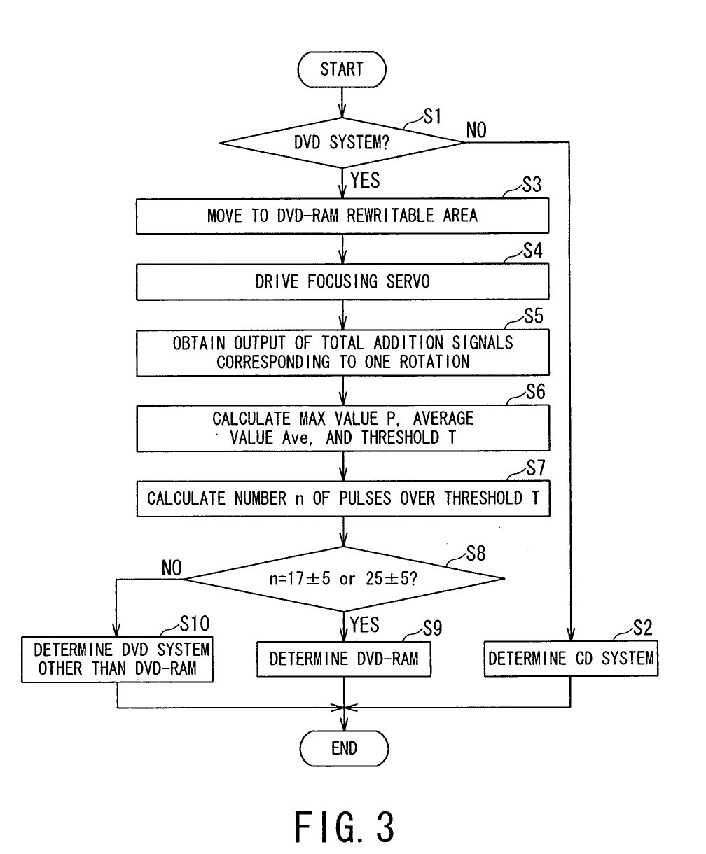

FIG. 3 is a flowchart showing one routine for specifying the optical disc 1, by the optical disc apparatus 10 shown in FIG. 1, the optical disc 1 having the portions with the high reflectance, regularly arranged in the circumferential direction of the optical disc 1, on the basis of information on the reflection of the optical disc 1. Referring to FIG. 3, the routine for specifying the type of disc is shown, in the case of the DVD-RAM having the CAPA as the optical disc 1, having the portions with a high reflectance that are regularly arranged in the circumferential direction. As shown in FIG. 3, reference characters with a symbol S and numerals denote steps in the flowchart.

It is noted in the routine that the output from the tracking control circuit 23b is zero (track-off state, that is, the state without the tracking servo).

In the flowchart shown in FIG. 3, the routine starts when the optical disc apparatus 10 recognizes that the optical disc 1 is loaded and then shifts to step S1.

First, in step S1, the CD/DVD determining unit 31a determines, with the general method, whether the optical disc 1 is a CD system or a DVD system. When the optical disc 1 is the CD system, the routine advances to step S2. On the other hand, when the optical disc 1 is the DVD system, the processing advances to step S3.

For example, upon using the difference in thickness between the CD system and the DVD system, the CD/DVD determining unit 31a controls the focusing control circuit 22b to move the focal point of laser beams from the front portion of the surface of the optical disc 1 to the depth side of the recording layer or from the depth side of the recording layer to front portion of the surface. During the movement, the CD/DVD determining unit 31a monitors the output (reflection strength) of the total-addition-signal generating circuit 21.

The total addition signals (strength of reflection light) have peaks on the surface and the recording layer. Therefore, the distance from the surface to the recording layer of the optical disc 1 can be calculated on the basis of a time required until the two peaks corresponding to the surface and the recording layer appear in the total addition signals. The CD/DVD determining unit 31a calculates the distance and compares the calculated distance with data on the distance from the surface to the recording layer of the CD system and the DVD system, recorded in advance to the ROM 33, thereby determining whether the optical disc 1 is the CD system or the DVD system.

Subsequently, in step S2, the type-of-disc determining unit 31b receives, from the CD/DVD determining unit 31a, information indicating that the optical disc 1 is the CD system, and the information indicating that the optical disc 1 is the CD system is output to the host device 40 via the interface circuit 35. Then, the routine ends.

On the other hand, in step S3, the thread motor drive unit 31c drives the thread motor 24a via the thread motor control circuit 24b, thereby moving the pickup unit 11 so that the laser beams are emitted to a rewritable area of the DVD-RAM.

Subsequently, in step S4, the focusing servo executing unit 31d drives the objective lens moving unit 13 via the focusing control circuit 22b to control the laser beams to be in the just-focusing state. As a consequence, the optical spot (focal point) of the laser beams focused by the objective lens 12 is just-focused on the rewritable area of the DVD-RAM.

Subsequently, in step S5, the obtaining unit 31e drives the spindle motor 25a via the spindle motor control circuit 25b, thereby driving the optical disc 1. The obtaining unit 31e obtains at least the output of the total addition signals corresponding to one rotation from the total-addition-signal generating circuit 21, and stores the obtained output to a predetermined area on the RAM 32.

Subsequently, in step S6, the threshold calculating unit 31f reads the output of the total addition signals corresponding to the one rotation of the optical disc 1 from a predetermined work area of the RAM 32, and calculates the maximum value P and the average value Ave. The threshold T is calculated on the basis of the following threshold calculation expression (1) stored in advance in the ROM 33 by using the calculated maximum value P and the average value Ave.

T=(((a×P)+(b×Ave))+c)/d (1)

Herein, a, b and c denote arbitrary integers and d denotes an arbitrary integer except for zero. Values of the integers a, b, c, and d may be stored in advance to the ROM 33 in the state in which the integers are substituted to expression (1) or the values of the integers input by a user may be properly used.

For example, if a=b=1, c=0, and d=2, the threshold calculation expression (1) can be written as shown by the following expression (2).

T=(P+Ave)/2 (2)

Subsequently, in step S7, the number-of-peaks calculating unit 31g reads the output of the total addition signals corresponding to one rotation of the optical disc 1 from a predetermined work area on the RAM 32, compares the read output with the threshold T, and calculates the number n of pulses (peaks) over the threshold T.

Subsequently, in step S8, the checking unit 31h compares the number of stored CAPAs (the number of portions with the high reflectance) stored in advance in the ROM 33 with the number n of peaks over the threshold T. As the number of stored CAPAs, 17 (standard value of the DVD-RAM (Ver1)) and 25 (standard value of the DVD-RAM (Ver2) are exemplified.

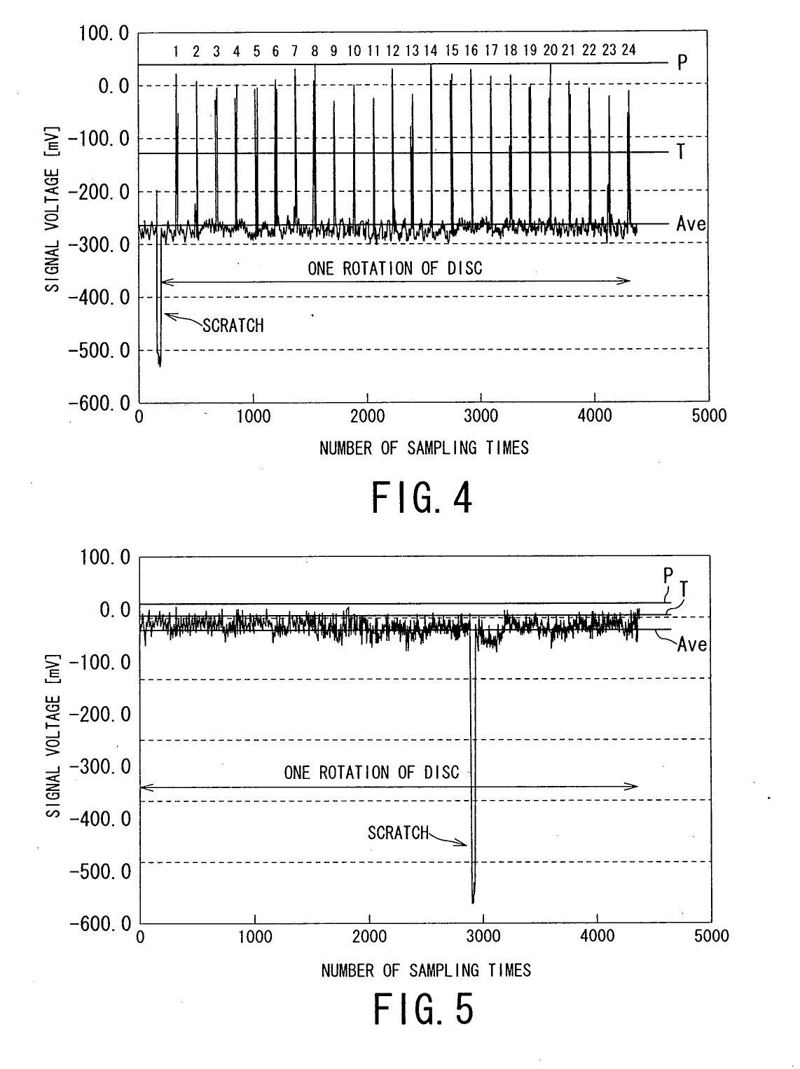

FIG. 4 is an explanatory diagram showing relationships between total addition signals corresponding to one rotation of a DVD-RAM (Ver2) and a threshold T calculated on the basis of expression (2). FIG. 5 is an explanatory diagram showing a relationship between total addition signals corresponding to one rotation of an optical disc other than the DVD-RAM and a threshold T calculated on the basis of expression (2).

Referring to FIGS. 4 and 5, an anomalous downward peak is caused by a scratch. The strength of reflection light from the scratch extremely deteriorates due to the scratch.

Referring to FIG. 4, since the scratch is overlapped to one portion of CAPA, the number n of peaks over the threshold T is 24 in the example shown in FIG. 4. That is, although the number n of peaks does not match 17 and 25 serving as the number of stored CAPAs, the number n of peaks is approximate to 17 and 25.

Referring to FIG. 5, the number n of peaks is much larger than the number of stored CAPAs. This is because there are not any portions with the high reflectance like the CAPA in the optical disc other than the DVD-RAM. As will be understood with reference to FIG. 5, the number n of peaks neither matches nor is approximate to the number of stored CAPAs in the optical disc other than the DVD-RAM.

It will be easily understood that the optical disc 1 is frequently damaged and the scratch is overlapped to the CAPA as shown in FIG. 4. Even when the optical disc 1 is a DVD-RAM, this scratch cannot allow the number n of peaks to match the number of stored CAPAs. Therefore, upon determining whether or not the optical disc 1 is a DVD-RAM, it is practical not only that the number n of peaks matches the number of stored CAPAs but also an error of ±5 is permitted to the number of stored CAPAs.

As a consequence of checking, when the number n of peaks matches the number of stored CAPAs or, when the number n of peaks does not match it but the absolute of the difference between the number n of peaks and the number of stored CAPAs is within 5, the checking unit 31h sends the number of stored CAPAs corresponding to the number n of peaks to the type-of-disc determining unit 31b and then the processing advances to step S9. On the other hand, if the absolute of the difference between the number n of peaks and the number of stored CAPAs is not less than 6, the processing advances to step S10.

Subsequently, in step S9, the type-of-disc determining unit 31b receives the number of stored CAPAs of the optical disc 1 from the checking unit 31h and reads from the ROM 33 the type of optical disc correlated with the number of stored CAPAs. For example, when the number of stored CAPAs of the optical disc 1 received from the checking unit 31h is 25, the type-of-disc determining unit 31b determines that the optical disc 1 is a DVD-RAM (Ver2). Then, the routine ends.

On the other hand, in step S10, the type-of-disc determining unit 31b determines that the optical disc 1 is the DVD system but a system except for the DVD-RAM. Then, the routine ends.

Through the above routine, it is possible to specify the optical disc 1 having regularly-arranged portions with the high reflectance in the circumferential direction of the optical disc on the basis of the information on the reflection to the optical disc.

The optical disc apparatus 10 shown in FIG. 1 determines whether or not the optical disc 1 is the DVD-RAM, only by using the number of CAPAs corresponding to one circumference of the optical disc in the track-off state, excluding the determination as whether the optical disc 1 is the CD system or the DVD system. Therefore, as compared with the conventional technology for determining the optical disc, the number of steps to the determination is small. Therefore, the optical disc apparatus 10 can more easily and faster determine whether or not the optical disc 1 is the DVD-RAM, as compared with the conventional technology for determining the optical disc.

Further, the optical disc apparatus 10 according to the first embodiment determines, by using the measurement of the number of portions with the high reflectance, whether or not the optical disc 1 is the DVD-RAM. The portions with the high reflectance have a reflectance greatly different from that at the positions except the portions with the high reflectance (refer to FIG. 4). Therefore, the optical disc apparatus 10 can be applied under the environment with high noise. Thus, even if this embodiment is applied in the track-on state, the optical disc apparatus 10 can determine, with high reliability, whether or not the optical disc 1 is the DVD-RAM.

Furthermore, the optical disc apparatus 10 can determine, in the track-off state, whether or not the optical disc 1 is the DVD-RAM. Therefore, the optical disc apparatus 10 can be applied even to a read-only device that cannot track-on the DVD-RAM in principle.

In general, the read-only device (DVD-ROM dedicated device, etc.) applies a DVD system using the differential from a pit train as an important detecting system of the TE signal in the tracking servo. However, data may not be recorded to the DVD-RAM, that is, there may not be any pits. Therefore, the read-only device does not obtain the TE signal from the DVD-RAM that does not record the data and can not track-on the DVD-RAM. If the DVD-RAM that does not record the data is erroneously loaded to the read-only device that determines the type of optical disc in the track-on state, the tracking servo can be erroneously operated.

On the other hand, the optical disc apparatus 10 can determine whether or not the optical disc is the DVD-RAM in the track-off state. Therefore, the optical disc apparatus 10 is applied and even the read-only device can stably determine whether or not the optical disc is the DVD-RAM.

Further, the optical disc apparatus 10 determines, only by the number of CAPAs (portions with a high reflectance), whether or not the optical disc is the DVD-RAM. Therefore, as long as the optical disc having the portions with the high reflectance in the circumferential direction of the optical disc as well as the DVD-RAM, the optical disc apparatus 10 can be applied. Thus, if a new optical disc that will appear in the market in the future has portions with a high reflectance, regularly-arranged in the circumferential direction of the optical disc, obviously, the optical disc apparatus 10 can be applied. In this case, attention is paid to a point that the number of portions with the high reflectance stored in the ROM 33 and the type of the new optical disc correlated with the portions with the high reflectance should be added in advance to the type of optical disc correlated with the number of portions with the high reflectance.

Next, a description will be given of an optical disc apparatus 10 according to the second embodiment of the present invention.

According to the second embodiment, the calculating method of the number n of peaks is different from that according to the first embodiment. The function of the number-of-peaks calculating unit 31g in the CPU 31 and the data stored in advance to the ROM 33 in the optical disc apparatus 10 according to the first embodiment are different from those in the optical disc apparatus 10 according to the second embodiment. Other structures and operations according to the second embodiment are similar to those of the optical disc apparatus 10 according to the first embodiment, the same reference numerals therefore denote the same components, and a description thereof is omitted.

The ROM 33 stores a start program of the optical disc apparatus 10, an optical-disc determining program, and various data necessary for executing the programs. As various data, the ROM 33 stores in advance at least a hysteresis voltage α necessary for calculating the number n of peaks in addition to the data on the distance from the surface to the recording layer of the CD system and the DVD system, the threshold calculation expressions, the number of portions with the high reflectance corresponding to one circumference and the type of optical discs correlated with the number of portions with the high reflectance.

The number-of-peaks calculating unit 31g has a function for reading the output of the total addition signals corresponding to one rotation of the optical disc 1 from a predetermined work area on the RAM 32 and the hysteresis voltage α stored in advance from the ROM 33. Further, the number-of-peaks calculating unit 31g has a function for calculating that the output of the total addition signal is a number n of pulses (peaks) that is not less than a value (T+α) obtained by adding the hysteresis voltage α to the threshold T to a value and is not more than a value (T−α) obtained by subtracting the hysteresis voltage α from the threshold T.

Incidentally, upon calculating the number n of pulses (peaks), the number-of-peaks calculating unit 31g may calculate, as n, the number of pulses (peaks) at which the output of the total addition signal is not more than T−α and is not less than T+α.

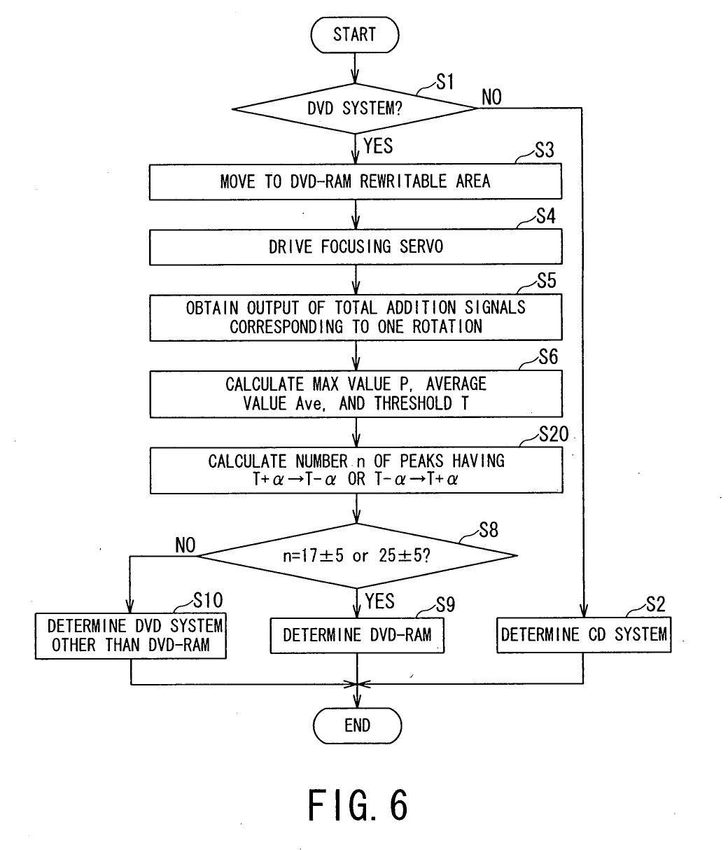

FIG. 6 is a flowchart showing another routine for specifying, by the optical disc apparatus 10 shown in FIG. 1, the optical disc 1 having the portions with the high reflectance, regularly arranged in the circumferential direction of the optical disc 1, on the basis of information on the reflection of the optical disc 1. FIG. 6 shows a routine for specifying the type of disc in the case of a DVD-RAM having CAPAs as the portions with the high reflectance. Referring to FIG. 6, reference characters with a character S and numerals denote steps in the flowchart. Further, the same steps as those in FIG. 3 denote the same ones, and a description thereof is not given again.

In step S20, the number-of-peaks calculating unit 31g reads the output of the total addition signals corresponding to one rotation of the optical disc 1 from a predetermined work area on the RAM 32, and the hysteresis voltage α stored in advance in the ROM 33, and calculates the number n of pulses (peaks) at which the output of the total addition signals is not less than T+α and is not more than T−α.

Subsequently, in step S8, the checking unit 31h compares the number of stored CAPAs (the number of portions with the high reflectance) stored in advance in the ROM 33 with the number n of peaks calculated by the number-of-peaks calculating unit 31g. The number of stored CAPAs can be, e.g., 17 (standard value of the DVD-RAM (Ver1)) and 25 (standard value of the DVD-RAM (Ver2)).

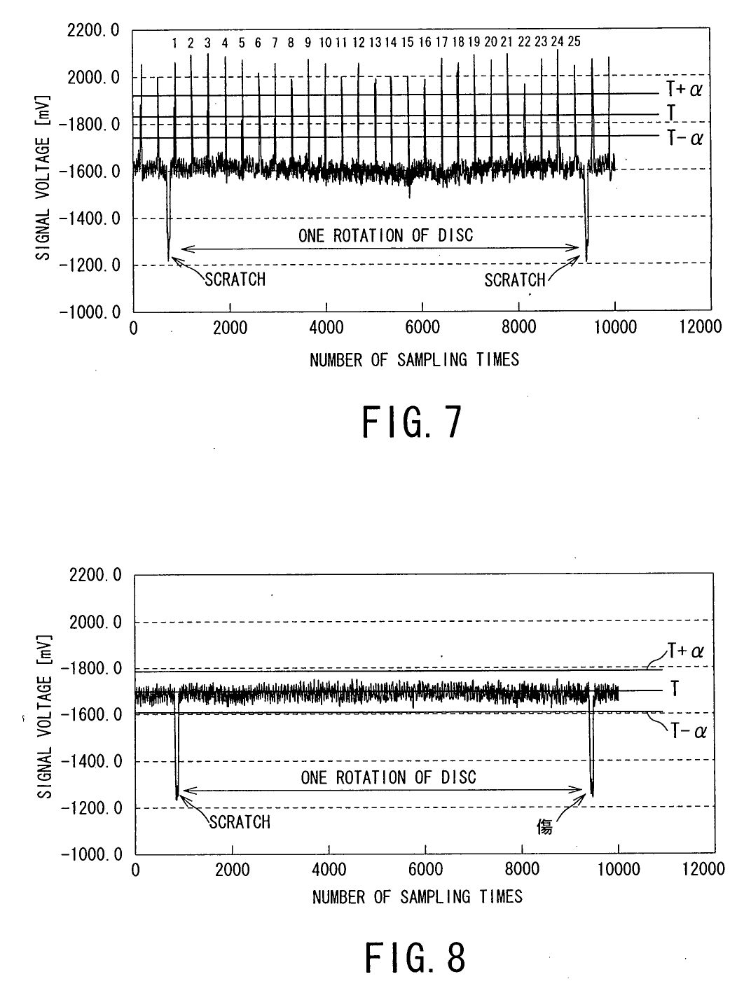

FIG. 7 is an explanatory diagram showing a relationship between total addition signals corresponding to one rotation of a DVD-RAM (Ver2), a threshold T calculated on the basis of expression (2), and the threshold T±hysteresis voltage α. FIG. 8 is an explanatory diagram showing a relationship between total addition signals corresponding to one rotation of an optical disc other than the DVD-RAM, a threshold T calculated on the basis of expression (2), and a threshold T±hysteresis voltage α. Referring to FIGS. 7 and 8, a downward peak on the most left side is caused by a scratch.

Referring to FIG. 7, since the scratch is overlapped to one portion of CAPA, the number n of peaks is 25 when the output of the total addition signals is not less than T+α and is not more than T−α (or the output of the total addition signals is not more than T−α and is not less than T+α).

As will be obviously understood with reference to FIG. 8, the number n of pulses (peaks) cannot match the number of stored CAPAs when the output of the total addition signals corresponding to one rotation of the optical disc other than the DVD-RAM is not less than T+α and is not more than T−α (or the output of the total addition signals is not more than T−α and is not less than T+α).

As a result of matching, when the number n of peaks matches the number of stored CAPAs or, when the number n of peaks does not match it but the absolute of the difference between the number n of peaks and the number of stored CAPAs is within 5, the checking unit 31h sends the number of stored CAPAs corresponding to the number n of peaks to the type-of-disc determining unit 31b and then the processing advances to step S9. On the other hand, if the absolute of the difference between the number n of peaks and the number of stored CAPAs is not less than 6, the processing advances to step S10.

Further, with the optical disc apparatus 10 according to the second embodiment, the same advantages as those according to the first embodiment are obtained.

Furthermore, the optical disc apparatus 10 according to the second embodiment uses the hysteresis voltage α. Therefore, with the optical disc apparatus 10, it is possible to remove high noise that is slightly over the threshold T but does not reach the maximum value P. Therefore, with the optical disc apparatus 10 according to the second embodiment, the DVD-RAM can be determined with high reliability.

Incidentally, the hysteresis voltage α may be not only the value stored in advance in the ROM 33 but also a value obtained by multiplying a constant rate to the difference (P−Ave) between the maximum value P and the average value Ave of the total addition signals obtained by the obtaining unit 31e. In this case, the constant rate is stored in advance in the ROM 33. For example, if the constant rate is 30%, (P−Ave)×0.3 is set as the hysteresis voltage α and is used for calculating the number n of peaks.

The invention is not limited to the embodiments per se. It is possible to modify and embody the elements in a range not departing from the spirit of the invention at an implementation stage.

For example, upon applying the optical disc apparatus 10 to a device (DVD-dedicated device, etc.) using only the DVD system according to the present invention, step S1 in FIGS. 3 and 6 is not required.

Further, the output of the total addition signals used for calculating the maximum value P and the average value Ave is not limited to that corresponding to one rotation and may be that corresponding to a plurality of rotations.

It is possible to form inventions of various forms according to appropriate combinations of the plural elements disclosed in the embodiments. For example, several elements may be deleted from all the elements described in the embodiments. Further, the components according to the different embodiments may be properly combined.

What is claimed is:

1. An optical disc apparatus comprising:
a storing unit configured to store certain information, such information comprising (i) a threshold calculation expression, (ii) the number of portions with high reflectance corresponding to one circumference of an optical disc, wherein the portions with high reflectance are regularly arranged in the circumferential direction of the optical disk, and (iii) the type of optical disc having the portions with high reflectance, wherein the type correlates to the number of portions with high reflectance;
an obtaining unit configured to obtain an output of total addition signals, corresponding to one or more rotations of a loaded optical disc;
a threshold calculating unit configured to calculate a maximum value and an average value of the output of the total addition signals, and further configured to calculate a threshold on the basis of the threshold calculation expression by using the calculated maximum value and the average value;
a number-of-peaks calculating unit configured to calculate the number of peaks of the output of the total addition signals, each peak corresponding to one rotation of the loaded optical disc, above the threshold;
a checking unit configured to compare the number of peaks with the number of portions with high reflectance; and
a type-of-disc determining unit configured to determine, when the number of portions with high reflectance matching the number of peaks is stored in the storing unit or when the number of portions with high reflectance at which an absolute of difference from the number of peaks is not more than 5 is stored in the storing unit, that the type of loaded optical disc is the type of optical disc having the portions with high reflectance, wherein the type correlates to the number of portions with high reflectance.

2. The optical disc apparatus according to claim 1, wherein the storing unit is further configured to store a hysteresis voltage, and wherein the number-of-peaks calculating unit is further configured to calculate the number of peaks at which the output of the total addition signals changes from a value not less than that obtained by adding the hysteresis voltage to the threshold to a value not more than that obtained by subtracting the hysteresis voltage from the threshold.

3. The optical disc apparatus according to claim 1, wherein the storing is unit further configured to store a hysteresis voltage, and the number-of-peaks calculating unit is further configured to calculate the number of peaks at which the output of the total addition signals changes from a value not more than that obtained by subtracting the hysteresis voltage from the threshold to a value not less than that obtained by adding the hysteresis voltage to the threshold.

4. An optical disc determining method comprising the steps of:
obtaining an output of total addition signals corresponding to one rotation of a loaded optical disc;
calculating a maximum value and an average value of the output of the total addition signals and further calculating a threshold by using the calculated maximum value and average value;
calculating the number of peaks of the output of the total addition signals corresponding to one rotation of the loaded optical disc, over the threshold;
checking the number of peaks with the number of portions with high reflectance corresponding to one rotation of an optical disc, wherein the portions with high reflectance are regularly arranged in the circumferential direction; and
determining, when the number of peaks matches the number of portions with high reflectance or when an absolute of difference between the number of peaks and the number of portions with high reflectance is not more than 5, that the type of loaded optical disc is the type of optical disc having the portions with high reflectance, wherein the type correlates to the number of portions with high reflectance.

5. The optical disc determining method according to claim 4, wherein the step of calculating the number of peaks comprises calculating the number of peaks at which the output of the total addition signals changes from a value not less than that obtained by adding a hysteresis voltage set in advance to the threshold to a value not more than that obtained by subtracting the hysteresis voltage from the threshold.

6. The optical disc determining method according to claim 4, wherein the step of calculating the number of peaks comprises calculating the number of peaks at which the output of the total addition signals changes from a value not more than that obtained by subtracting a hysteresis voltage set in advance to the threshold to a value not less than that obtained by adding the hysteresis voltage to the threshold.
